(19) United States
(12) Patent Application Publication
(10) Pub. No.: US 2005/0109812 A1
(43) Pub. Date: May 26, 2005

(54) Setting tool

(76) Inventors: Gerhard Ehmig, Rankweil (AT); Tilo Dittrich, Gams (CH); Gebhard Gantner, Nenzing (AT)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/995,739

(22) Filed: Nov. 22, 2004

(30) Foreign Application Priority Data
Nov. 26, 2003 (DE) 103 55 375.4

(51) Int. Cl. B25C 1/14

(52) U.S. Cl. 227/8; 227/10

(57) ABSTRACT

A combustion power-operated setting tool, includes a setting mechanism (12), and a safety device (30) for preventing a setting process upon an operational temperature of the setting mechanism (12) exceeding a predetermined threshold temperature, with the safety device (30) including a temperature-sensitive servo element (31) having a first position (32) when the operational temperature of the setting mechanism (12) is below the predetermined threshold temperature and in which a setting process with the setting tool (10) can be carried out, and a second position (33) when the operational temperature of the setting mechanism exceeds the predetermined threshold temperature and in which the setting process cannot be carried out.

### BACKGROUND OF THE INVENTION

1. Field of the Invention

The present invention relates to a combustion power-operated setting tool including a setting mechanism and a safety device that prevents a setting process from being carried out when an operational temperature of the setting tool or the setting mechanism exceeds a predetermined threshold temperature.

2. Description of the Prior Art

Setting tools of the type described above can be driven with solid, gaseous, or liquid fuels or propellants. During a setting process, a setting piston of a setting tool, which is displaceable in a piston guide, is driven by expanding gases produced by combustion of a propellant. With the setting piston, fastening elements can be driven in constructional components.

During combustion or a thermal conversion of a propellant, a large amount of heat energy is produced, which leads to a strong thermal loading of certain components of a setting tool. This leads to functional disturbances during operation of the tool and an increased wear of the tool components.

U.S. Pat. No. 6,123,241 discloses a combustion-engined setting tool having a combustion chamber for combusting a gaseous fuel. For monitoring the combustion chamber temperature, a temperature sensor is provided. The obtained temperature data are used for determining the amount of fuel that should be fed into the combustion chamber in order to obtain an optimal combustion. When the data lie outside of an acceptable range, a microprocessor turns off the setting tool.

However, the timing of the turning-off of the setting tool is not precisely defined.

A drawback of the known setting tool consists in that the control with using a microprocessor is very expensive and interference-prone because of occurring high reaction forces.

Accordingly, an object of the present invention is to provide a setting tool of the type described above in which the drawbacks of conventional setting tools are eliminated.

Another object of the present invention is to provide a setting tool of the type described above characterized by a reliable operation.

A further object of the present invention is a setting tool of the type described above and which can be economically produced.

### SUMMARY OF THE INVENTION

These and other objects of the present invention, which will become apparent hereinafter, are achieved by providing a setting tool of the type described above and in which the safety device includes a temperature-sensitive servo mechanism having a first position when the operational temperature of the setting tool or the setting mechanism is below the predetermined threshold temperature and in which a setting process with the setting tool can be carried out, and a second position when the operational temperature of the setting tool and the setting mechanism exceeds the predetermined threshold temperature and in which the setting process cannot be carried out.

The provision of such a temperature controlled pure mechanical servo mechanism permits to prevent a setting process upon overheating of the setting tool in a simple and reliable way. The servo mechanism is very-robust, hardly susceptable to wear, and insures a long service life of the setting tool. Another advantage of the inventive servo mechanism consists in that the locking function cannot be altered by some manipulation.

In a particularly stable embodiment of the setting tool, the safety device has a locking member that cooperates with the servo mechanism and is displaced thereby, upon the operational temperature of the setting mechanism exceeding the threshold temperature, from its release position into its servo position in which it lockingly engages a displaceable functional element of the setting tool, and is displaced by the servo mechanism, upon the operational temperature of the setting mechanism being below the threshold temperature, from its locking position into its release position in which it becomes disengaged from the functional element.

The functional element, as a result of its engagement by the locking member either becomes immovable, or its displacement in the setting tool is blocked by the servo mechanism. The functional element, within the meaning of the invention, can be represented by all of the constructional or accessory components of the setting tool necessary for carrying out a setting process.

The functional element can, advantageously, be represented, e.g., by a press-on member that forms part of a safety chain of a setting tool. The setting process is reliably prevented by locking or blocking of the safety chain by immobilizing the press-on member.

It could be convenient to use the firing pin or a least a component of an ignition chain as a functional element. Here, likewise, the setting process is reliably prevented by blocking or locking the firing pin or the ignition chain.

The functional element can also be formed by a catridge strip. The setting process then can be reliably prevented by interrupting or blocking the delivery of a new catridge or propellant to the catridge socket or the combustion chamber of a setting tool.

The functional element can also be formed by a fastening element strip. The inventive setting tool includes a safety mechanism that prevents a setting process in the absence of a fastening element in the receptacle in which the fastening element is lodged before being driven in. Such a safety mechanism reliably prevents a following setting process by interrupting or blocking the delivery of a fastening element in its receptacle in the outlet part of the setting tool.

Advantageously, the temperature controlled servo mechanism has a temperature-sensitive servo element. With this servo element, in a simple manner, an increase of the temperature of the setting tool or the setting mechanism above the threshold temperature can be reliably determined, with conversion of the temperature increase directly into the displacement of the servo element. Also, the reduction of the temperature below the threshold temperature can be detected and transformed in the displacement of the servo element. Advantageously the temperature-sensitive servo element biases the locking member in a direction of its locking position upon the operational temperature of the setting mechanism exceeding the threshold temperature.

Advantageously, the temperature sensitive servo element is formed at least partially of a memory metal. The advantage of forming the servo element of a memory metal consists in that its length or shape momentarily changes at switching point temperature.

Ideally, the switching point temperature corresponds to the threshold temperature for turning off or locking of the setting tool. This can be achieved by a well-aimed adjustment of the memory metal alloy.

Advantageously, other temperature-sensitive actuators, e.g., of bi-metals or certain mineral materials can be used as servo elements. Such servo elements have a constant displacement at increased or decreased temperature.

It is convenient when the temperature-sensitive servo member biases the locking member in the direction of its locking position against a biasing force of at least one spring.

The spring faciliates return of the servo mechanism into its release position. In particular, when an servo element of a memory metal is used, changing of its shape or reduction of its length, upon the reduction of the temperature below the threshold or switching point temperature, is initiated and accelerated by the spring.

It is convenient when the temperature-sensitive servo element is formed as a spring made of a memory metal. The spring can be formed as a memory metal tension or compression spring. By forming the servo element as a spring, the constructional length of the servo mechanism can be reduced.

It can be advantageous to form the servo element as a memory wire. In this case, a particularly large operational path of 3-4% of the length of the memory metal wire can be achieved.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a partially cross-sectional side view of a setting tool according to the present invention which is pressed against a constructional component;

FIG. 2 a cross-sectional view along line II-II in FIG. 1;

FIG. 3 a partially cross-sectional side view of the setting tool shown in FIG. 1 in a condition in which it is not pressed against a constructional component;

FIG. 4 a cross-sectional view along line IV-IV in FIG. 3;

FIG. 5 a longitudinal cross-sectional view of a first embodiment of a temperature-sensitive servo mechanism in its locking position;

FIG. 6 a cross-sectional view of the servo mechanism shown in FIG. 5 in its release position;

FIG. 7 a longitudinal cross-sectional view of a further embodiment of an servo mechanism in its locking position;

FIG. 8 an end, partially cross-sectional view of the temperature-sensitive servo mechanism shown in FIG. 7 in the locking position of the mechanism;

FIG. 9 an end, partially cross-sectional view of the temperature-sensitive servo mechanism shown in FIG. 8 in a release position thereof;

FIG. 10 a partially cross-sectional longitudinal view of a still further embodiment of a temperature sensitive mechanism in a release position thereof;

FIG. 11 a longitudinal, partially cross-sectional view of the servo mechanism shown in FIG. 10 in its locking position;

FIG. 12 a partially cross-sectional, longitudinal detail view of another embodiment of a setting tool according to the present invention in a condition in which the setting tool is pressed against a constructional component;

FIG. 13 a partially cross-sectional, longitudinal, detail view of the setting tool shown in FIG. 12 in a condition in which it is not pressed against a constructional component.

FIG. 14 a partially cross-sectional, longitudinal, detail view of yet another embodiment of a setting tool according to the present invention in a condition in which the setting tool is not pressed against a constructional component;

FIG. 15 a partially cross-sectional, longitudinal, detail view of still another embodiment of a setting tool according to the present invention in a condition in which the setting tool is pressed against a constructional component; and

FIG. 16 a partially cross-sectional longitudinal, detail view of the setting tool shown in FIG. 15 in a condition in which it is not pressed against a constructional component.

### DETAILED DESCRIPTION OF THE PREFERRED EMBODIMENT

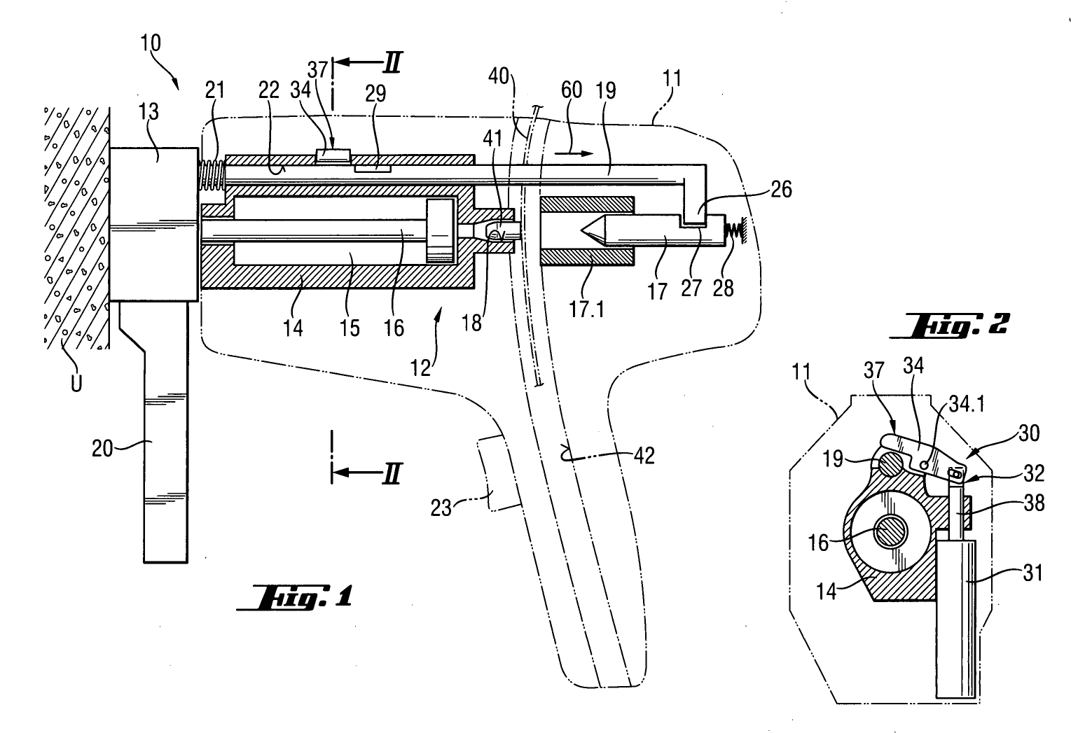

FIGS. 1 through 6 show a first embodiment of a setting tool according to the present invention. The setting tool 10 includes a housing 11 and setting mechanism 12 arranged in the housing 11. The setting mechanism 12 includes a piston guide 14 in a hollow chamber 15 of which, a setting piston 16 is displaceably arranged. The setting piston 16 is displaced by a propellant, e.g., in form of a cartridge 41 or by expandable combustion gases of the cartridge 41. At the rear end of the piston guide 14, there is provided a cartridge socket 18 for receiving the cartridge 41. The cartridges 41 are arranged on a cartridge strip 40 that is displaceable in a channel 42 formed in the setting tool 10. In front of the housing 11 and the piston guide 14, there is arranged an outlet member 13 from which sidewise, a magazine 20 with fastening elements projects. The outlet member 13 is supported against the housing 11 by at least one spring member 21. The outlet member can be supported directly against the piston guide 14. The spring member 21 surrounds a bar-shaped press-on member 19 that is secured to the press-on member 19. The piston guide 14 is displaceable in a guide 22 provided in the piston guide 14. The press-on member 19 forms part of a safety chain that should prevent actuation of the setting tool when the setting tool is not pressed with outlet member against the constructional component in the setting direction 65. The press-on member 19 has a section formed as an entrainment member 26 that engages, in the positions of the setting tool shown in FIGS. 1 and 3, in a recess 27 formed in a firing pin 17 displaceable in a firing pin guide 17.1. The firing pin 17 is supported at its end remote from the cartridge socket 18 against the housing 11. The firing pin 17 is supported against the housing 11 by a spring 28.

In the position shown in FIG. 1, the setting process can be initialed by actuation of the actuation switch 23 provided on the handle of the setting tool 10. Mechanical connection means (not shown) can connect the actuation switch 23 with the entrainment member 26 so that the latter would pivot out from the recess 27, releasing the firing pin 17 can be displaced towards the cartridge 41.

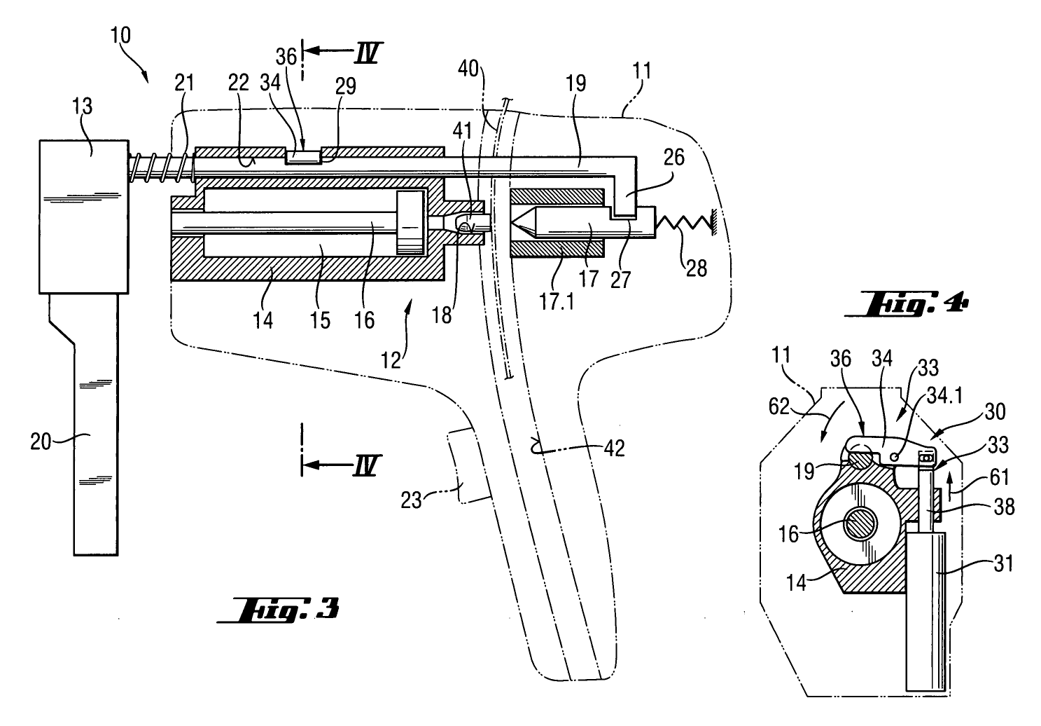

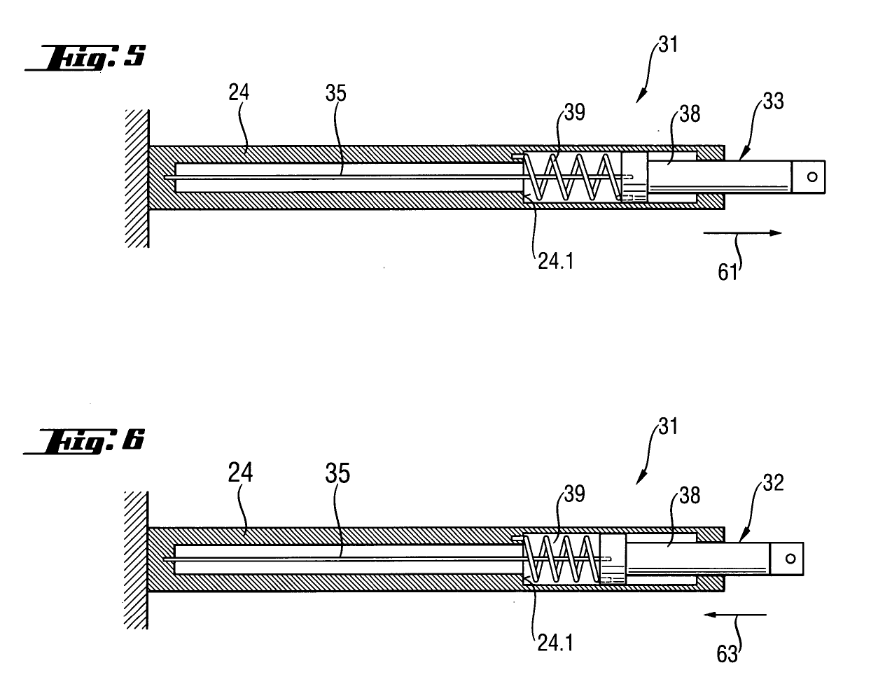

During a lasting operation, the setting tool 10 and primarily, the setting mechanism 12 become strongly heated. In order to prevent overheating of the setting tool or of the setting mechanism during operation of the setting tool and to prevent damage of the tool and harm to the tool user, there is provided on the tool a safety device generally designated with a reference numeral 30 which is particularly shown in FIGS. 2 and 4.

The safety device 30 includes an servo mechanism 31 that reacts to the temperature of the setting tool 10 and the setting mechanism 12 and the construction of which will be described more precisely further below. The servo mechanism 31 is arranged sidewise of the piston guide 14 and is pivotally connected by a transmission member 38 with a locking member 34 that is formed as a locking pawl. The locking member 34 is pivotally supported on a hinge support 34.1.

In FIG. 2, the servo mechanism 31 is shown in its first position 32 in which the servo mechanism 31 permits operation of the setting tool 10 and the setting mechanism 12 the temperature of which has not yet exceeded the threshold temperature. In the first position 32, the locking member 34 is its release position 37 in which it is withdrawn from a recess 29 formed in the press-on member 19. This provides for displacement of the press-on member 19 in direction 60 (see FIG. 1) and loading of the firing pin 17.

FIG. 4 shows the servo mechanism 31 in its second position 33 which the servo mechanism 31 assumes in response to a too high temperature of the setting mechanism 12. In the position 33, the servo mechanism 31 blocks the setting tool 10 from carrying-out a setting process. To this end, the servo mechanism 31 displaces the transmission member 38 in direction 61, pivoting the locking member 34 about the hinge support 34.1 in a direction 62 into its locking position 36. As a result, the locking member 34 engages with its free end in the recess 29 in the press-on member 19, as shown in FIGS. 3-4. In this position of the servo mechanism 31, the press-on member is located in its initial position in which the outlet member 13 is spaced from the housing 11 and does not stress or load the firing pin 17.

FIGS. 5-6 show in detail the servo mechanism 31 of the setting tool 10. The servo mechanism 31 has an elongate housing 24 in which an servo element 35, which is formed as a memory metal wire, is arranged for displacement parallel to the longitudinal extent of the housing 24. At one of its end the servo element 35 is fixedly secured to the housing 24 and is connected, at its opposite end, to the transmission member 38 that partially projects from the housing 24. Between a shoulder 24.1 formed in the housing 24 and the transmission member 38, there is arranged a spring 39 that is formed as a tension spring and biases the transmission member 38 and the servo member 35 towards the first position 32 of the servo mechanism 31 (see FIG. 6).

When, upon overheating of the setting tool 10, the servo element 35 is heated above a predetermined threshold or operating position temperature, the memory metal wire jumps out, displacing the transmission member 38 in the direction 61, and thereby displacing the servo mechanism 31 in its second blocking position 33 (FIG. 5). In the second position 33 of the servo mechanism 31, the locking member 34 is held in its locking position 36 by the servo mechanism 31 and its transmission member 38 (see FIG. 4).

Upon cooling of the setting tool 10 and of the settling mechanism 12, the servo element 35 is also cooled down. The spring 39 then becomes released after the servo element 35 of memory metal wire reaches its restoring temperature and assumes its original dimension. The transmission element 38 moves in direction 63 back into the housing 24, and the servo mechanism assumes its first position 32 in which the locking member 34 is held by the servo mechanism 31 and the transmission member 38 in its release position 37 (see FIG. 2).

In summary, the servo element 35 performs the following functions: temperature measurement (continuous, absolute), comparison of the temperature with the threshold temperature, carrying-out the locking function, comparison of the temperature with the restoring temperature, and release of the locking condition. The presetting of the threshold temperature, of the restoring temperature, and of the hystersis value can be effected by a predetermined selection of the memory metal.

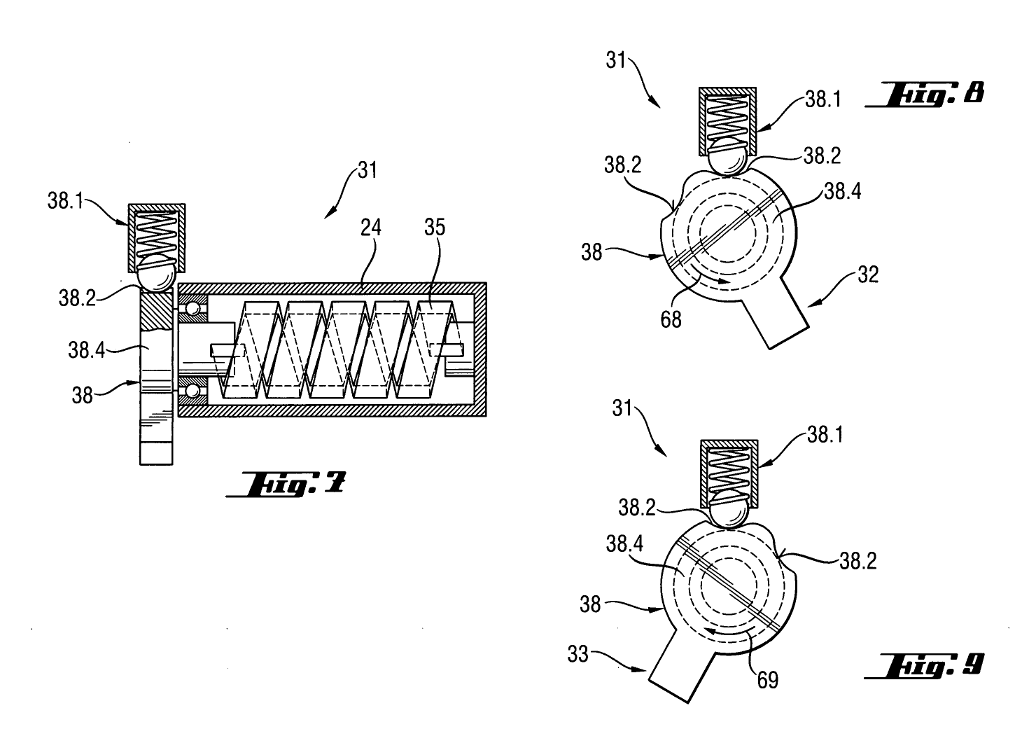

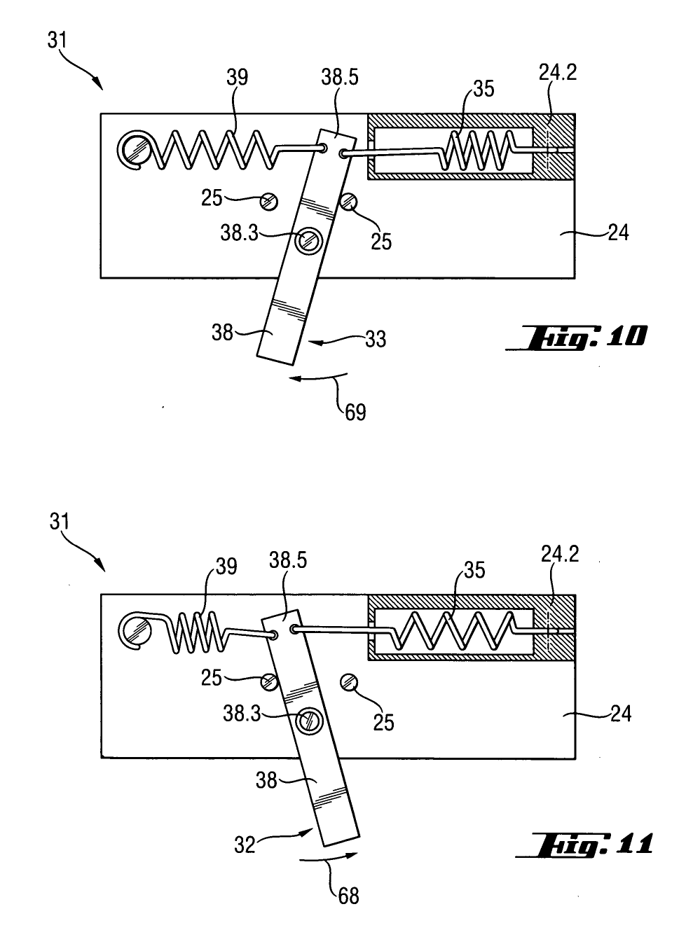

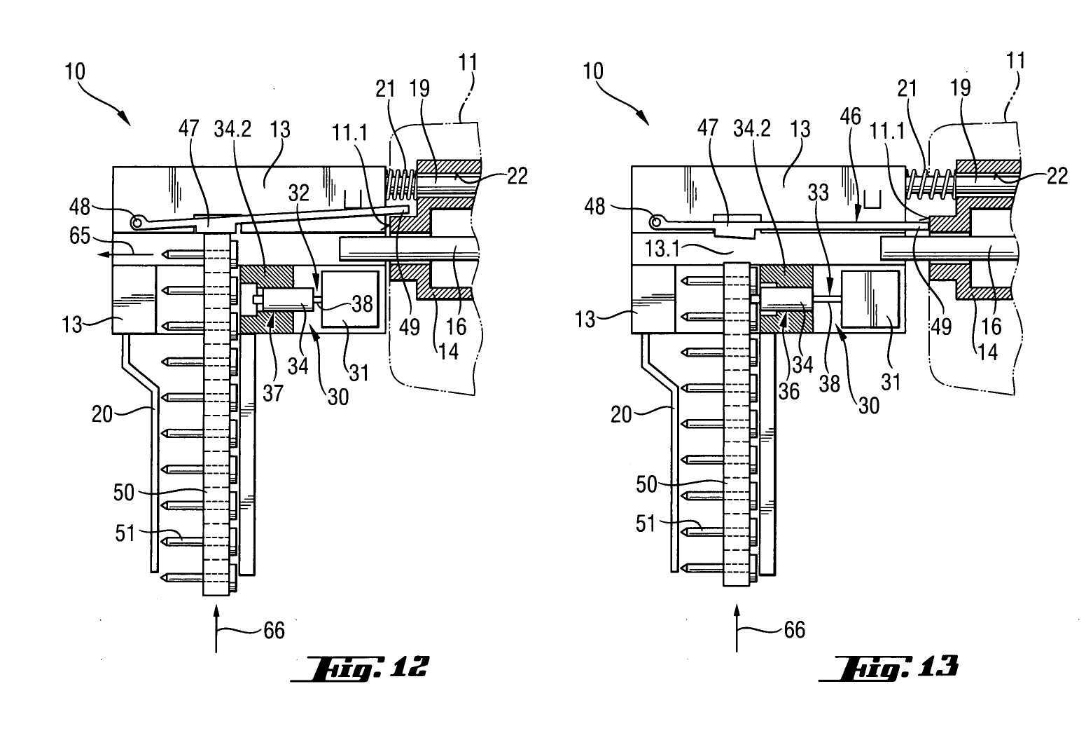

A further embodiment of an servo mechanism according to the present invention is shown in FIGS. 7-9. The servo mechanism, which is shown in FIGS. 7-9 has a bi-metal spiral that forms the servo element 35 arranged in the housing 24. One end of the servo element 35 is fixedly connected with the housing 24. The other, opposite end of the servo element 35 is secured to the transmission member 38 rotably arranged in the housing 24. The transmission member 38 has a circular section 38.4 on the circumferential surface of which, there are provided indentations 38.2 which cooperate with a locking device 38.1. Upon heating of the setting tool 10 or of the setting mechanism 12, the end of the servo element 35, which is connected with the transmission member 38, would rotate as a result of heating of the servo element. However, the transmission member 38 is held in its first position 32 by the locking device 38.1. Only after a certain temperature, which exceeds the predetermined threshold temperature, the torsional force, which is produced by the servo elements, becomes large enough to rotate the transmission member 38 in direction 69 (see FIG. 9) against the holding force of the divice 38.1, displacing the transmission member 38 from its first position 32 to its second position 33. The locking device 38.1 then engages in the second indentation 38.2, retaining the transmission member 38 in its second position 33. Upon cooling of the setting tool 10 or the setting mechanism 12, the servo element 35 rotates in the opposite direction, and again, when a predetermined temperature is reached, the torsional force of the servo element 35 becomes so high that it provides for rotation of the transmission member 38 in direction 68 (see FIG. 8), with the locking device 38.1 being forced out of the indentation 38.2. The transmission member 38 and with it, the servo mechanism 31 are displaced back into the first position 32. The servo mechanism 31, which is shown in FIGS. 7-9 can also be used in the setting tool shown in FIGS. 1-4. It is believed it would be superfluous to describe the operation of the servo mechanism 31 of FIGS. 7-9 in the setting tool 10 and, therefore, the reference is made to description made with reference to FIGS. 1-4.

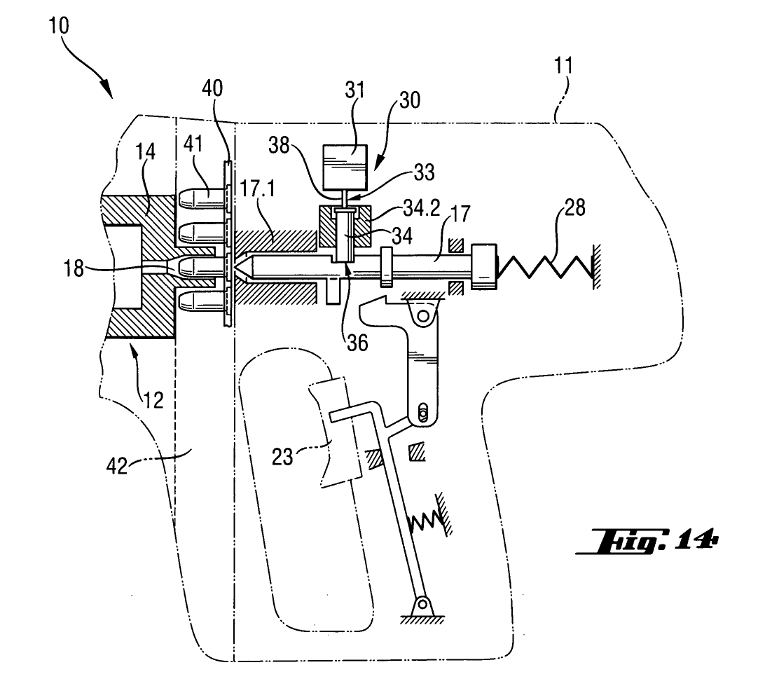

A still further embodiment of the servo mechanism is shown on FIGS. 10-11. In the embodiment show in FIGS. 10-11, the servo element 35 is formed as a memory metal tension spring that is arranged in a good heat-conducting housing section 24.2 of the housing 24 of the servo mechanism 31. One end of the servo element 35 is again fixedly connected with the housing 24 or the housing section 24.2, whereas the other, opposite end of the servo element 35 is secured to the transmission member 38 that is formed as a two-arm lever. Specifically, the other end of the servo element 35 is secured to a lever arm 38.5 located in the housing 24. In the housing 24, there is also arranged a spring 39 formed as a tension spring and having one of its ends secured to the housing 24 and the other of its ends secured to the same lever arm 38.5 of the transmission member 38 to which the other end of the servo element 35 is secured. As a result, the pull direction of the spring 39 is opposite to the pull direction of the servo element 35. The transmission member 38 is supported in the housing 24 on a hinge bearing or support 38.3. Stops 25, which are provided in the housing 24, limit the possible pivotal path of the transmission member 38. In FIG. 10, the servo mechanism 31 is located in its second position 33 in which the memory metal tension spring that forms the servo member 35, has a reduced length as a result of the temperature of the setting tool 10 or the setting mechanism 12 exceeding a threshold temperature. Because of the reduced length of the servo element 35, the spring 39 is stretched and is, thus, preloaded. A setting tool, which is provided with a servo mechanism 31 shown in FIGS. 10-11, occupies, in the position of the servo mechanism shown in FIG. 10, a non-operational position.

Upon cooling of the setting tool or of the setting mechanism, the spring 39 releases the servo element 35 after the restoring temperature is reached. The transmission member 38 pivots to its first position 32 or to its initial position. In this position of the servo mechanism 31, effecting a setting process with a setting tool is possible. The servo mechanism 31, which is shown in FIGS. 10-11, can also be used in the setting tool shown in FIGS. 1-4. It is believed it would be superfluous to describe the operation of the servo mechanism 31 of FIGS. 10-11 in the setting tool 10 and, therefore, the reference is made to description made with reference to FIGS. 1-4.

With reference to FIGS. 12-16, other embodiments of a setting tool would be described and in which other locations of the safety device according to the present invention are illustrated. With regard to reference numerals not referred to below, reference should be made to the description of the setting tool made with reference to FIGS. 1-4.

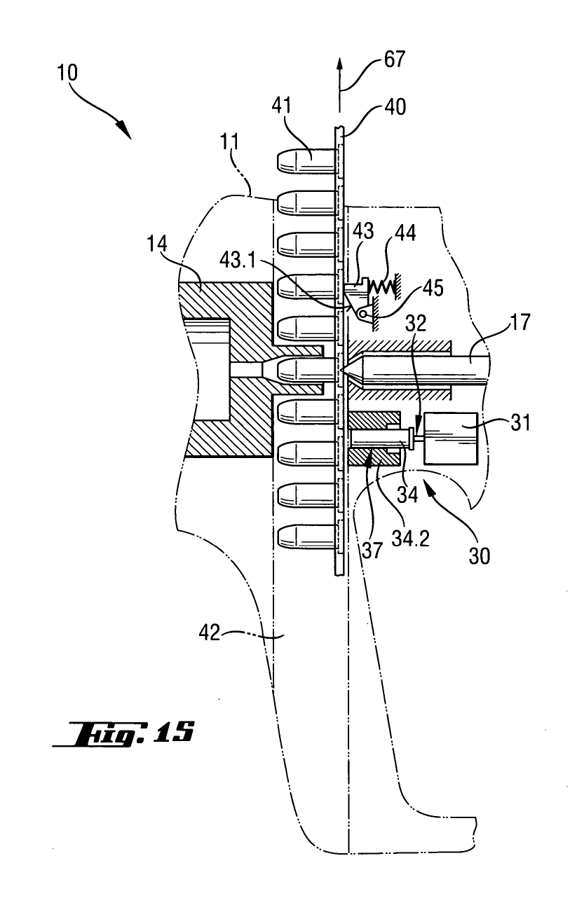

In the setting tool 10, which is shown in FIGS. 12-13, the safety device 30 is located in the region of the outlet member 13. The locking member 34 is formed as a cylindrical body displaceable in a guide 34.2. The locking member 34 can be displaced by the servo mechanism 31, upon the temperature of the setting tool or the setting mechanism exceeding the threshold temperature, from its release position 37, shown in FIG. 12, to its locking position 36, shown in FIG. 13 and in which, the locking member 34 engages lockingly a fastening element strip 50 located in the magazine 20. The engagement of the fastening element strip 50 by the locking member 34 prevents displacement of the fastening element strip 50 in the displacement direction 66. Thus, after a setting process, no fastening element 51 can be transported into the receiving chamber 13.1 of the outlet member 13. Thereby, sensor means 47, which is provided on the outlet member 13, remains in a locking position 46 in which it engages a stop 11.1 provided in the housing 11 or engages directly the piston guide 14. In this position 46, pressing of the setting tool 10 against a constructional component is prevented, and the press-on member 19 cannot be pushed back into the setting tool. In this safety position of the fastening element strip 50, effecting a setting process is not possible.

In the setting tool 10 shown in FIG. 14, the safety device 30 is arranged in the region of the setting took, with the locking member 34, which is displaceable in the guide 34.2, lockingly engaging the firing pin 17. In the locking position 36 of the locking member 34, which is shown in FIG. 14, actuation of the setting tool is not possible because the firing pin 17 cannot be displaced to its loading position in which the spring 28 is compressed.

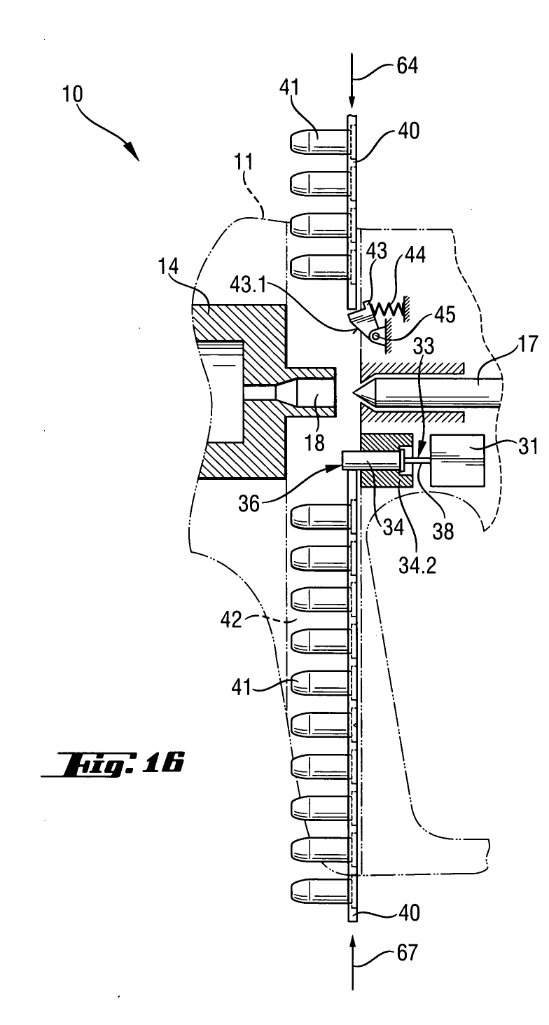

In the setting tool shown in FIGS. 15-16, the safety device 30 is arranged adjacent to channel 42 in which the cartridge strip 40 with cartridges 41 is displaceable. The locking member 34 is displaceable in the guide 34.2 that is open toward the channel 42. In the release position 37 of the locking member 34 which is shown in FIG. 15, the locking member 34 is pulled out of the channel 42, and the cartridge strip 40 can be displaced in the direction 67. When the temperature of the setting tool 10 or of the setting mechanism 12 exceeds the threshold temperature of servo mechanism 31, the locking member 34 is displaced by the transmission member 38 of the servo mechanism 31 into its locking position 36 shown in FIG. 16. In the locking position 36, the locking member 34 lockingly projects into the channel 42, and the cartridge strip cannot be displaced in a direction 67. Likewise, the cartridge strip 40 can be inserted into the channel 42 from the opposite side 64. In the upper region of the channel 42, there is provided a locking pawl 43 supported in the setting tool 10 on a hinge bearing or support 45. The pawl 43 is pressed into the channel 42 by a spring 44, blocking the displacement of the cartridge strip 40 from above in the direction 64. In the displacement direction 67, the locking pawl 43 can be displaced out of the channel 42 because of an inclination ramp 43.1.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

1. A combustion power-operated setting tool, comprising a setting mechanism (12); and a safety device (30) for preventing a setting process upon an operational temperature of the setting mechanism (12) exceeding a predetermined threshold temperature, the safety device (30) comprising a temperature-sensitive servo mechanism (31) having a first position (32) when the operational temperature of the setting mechanism (12) is below the predetermined threshold temperature and in which a setting process with the setting tool (10) can be carried out, and a second position (33) when the operational temperature of the setting mechanism exceeds the predetermined threshold temperature and in which the setting process cannot be carried out.

2. A setting tool according to claim 1, wherein the safety device (3) comprises a locking member (34) that cooperates with the servo mechanism (31) and is displaced thereby, upon the operational temperature of the setting mechanism (12) exceeding the threshold temperature, from a release position (37) thereof in a locking position (36) thereof in which it lockingly engages a displaceable functional element of the setting tool (10), and is displaced by the servo mechanism (31), upon the operational temperature of the setting mechanism (12) being below the threshold temperature, from the locking position (36) thereof into the release position (37) thereof in which it becomes disengaged from the functional element.

3. A setting tool according to claim 2, wherein the servo mechanism (31) comprises a temperature-sensitive servo member (35).

4. A setting tool according to claim 3, wherein the temperature-sensitive servo member (35) is formed at least partially of a memory metal.

5. S setting tool according to claim 3, wherein the temperature-sensitive servo member (35) is formed at least partially of a bi-metal.

6. A setting tool according to the claim 3, wherein the temperature-sensitive servo element (35) biases the locking member (34) in a direction of its locking position (36) upon the operational temperature of the setting mechanism exceeding the threshold temperature.

7. A setting tool according to claim 6 wherein the temperature-sensitive servo element (35) biases the locking member (34) in the direction of its locking position (36) against a biasing force of at least one spring (39).

8. A setting tool according to claim 3, wherein the temperature-sensitive servo element (35) is formed as a spring made entirely of the memory metal.

9. A setting tool according to claim 3, wherein the temperature-sensitive servo element (35) is formed as a memory metal wire.

10. A setting tool according to claim 2, wherein the functional element is formed as a press-on member (19).

11. A setting tool according to claim 2, wherein the functional element is formed as firing pin (17).

12. A setting tool according to claim 2, wherein the functional element is formed as a cartridge strip (40).

13. A setting tool according to claim 2, wherein the functional element is formed as a fastening element strip (50).
